(19) United States
(12) Patent Application Publication
(10) Pub. No.: US 2018/0293408 A1
(43) Pub. Date: Oct. 11, 2018

(54) PERIPHERAL DEVICE SECURITY

(71) Applicant: HEWLETT PACKARD ENTERPRISE DEVELOPMENT LP, Houston, TX (US)

(72) Inventors: Erik L YOUNG, Houston, TX (US); Andrew C CARTES, Cypress, TX (US); Richard Wei Chieh YU, Houston, TX (US)

(21) Appl. No.: 15/570,739

(22) PCT Filed: May 11, 2015
(86) PCT No.: PCT/US15/30144

§ 371 Date: Oct. 30, 2017

(51) Int. Cl. G06F 21/82; G06F 21/32

(52) U.S. Cl. CPC G06F 21/82; G06F 2221/2137; G06F 2221/2111; G06F 21/32

(57) ABSTRACT

In one implementation, a system for peripheral device security includes a hardware interface coupled to an out-of-band manager, and the out-of-band manager is to: authorize a peripheral device via the hardware interface; and load instructions from the peripheral device to a host interface.

### BACKGROUND

Service processors are processors, or other types of integrated circuits, that can be used to manage or co-manage specific functionality in a computer system. This functionality may include computer system diagnostics, power resource management, and remote computer system configuration and management. The service processors can be considered out-of-band processors and/or out-of-band managers.

### BRIEF DESCRIPTION OF THE DRAWINGS

FIG. 1 illustrates a diagram of an example of a system for peripheral device security consistent with the present disclosure.

FIG. 2 illustrates a diagram of an example computing device for peripheral device security consistent with the present disclosure.

FIG. 3 illustrates a diagram of an example of a peripheral device security system consistent with the present disclosure.

FIG. 4 illustrates a diagram of an example of a peripheral device security system consistent with the present disclosure.

FIG. 5 is a flow chart of an example of a method for peripheral device security consistent with the present disclosure.

### DETAILED DESCRIPTION

A number of methods, systems, and computer readable medium for peripheral device security are described herein. The peripheral device security systems, methods, and computer readable medium described herein can provide protection against system attacks via a hardware interface (e.g., universal serial bus (USB) port, near field communication (NFC) interface, micro-USB port, etc.). Previous solutions can be vulnerable to hardware interface attacks such as computer viruses that are uploaded via a physical USB port of the computing system. For example, a server can be vulnerable to computer viruses that are uploaded to the server by a peripheral device coupled to a physical USB port. As used herein a peripheral device can be a device that can be coupled to a computing system via a hardware interface. For example, a peripheral device can include, but not limited to: flash drive, mouse, keyboard, memory card, serial adapter, smart card, among other devices that can be coupled to a computing device via a hardware interface.

Traditional anti-virus systems may not be able to detect hardware interface attacks. The peripheral device security systems and methods described herein can be utilized to prevent various hardware interface attacks. Peripheral device security can include authorizing a user of the peripheral device. For example, authorizing the user can include authorizing a user's credentials to confirm that the user has authority to access the hardware interface. In addition, authorizing the user can include authorizing a user's physical location to confirm that the user is at or near the physical location of the hardware interface.

Peripheral device security can also include authorizing a peripheral device that is coupled to the hardware interface. Authorizing the peripheral device can include determining a device type and determining if the user of the peripheral device is authorized to utilize the peripheral device. In some examples, authorizing the peripheral device can include determining a number of authorized instructions for the peripheral device. The number of authorized instructions can be based on the determined device type and/or the user of the peripheral device. In some examples, only authorized instructions are allowed to be loaded to a host interface of a computing system. That is, unauthorized instructions are excluded from being loaded to the host interface from the peripheral device. Peripheral device security as described further herein can provide security against malicious hardware interface attacks. The peripheral device security can enable secure utilization of hardware interfaces on a computing device where security is essential.

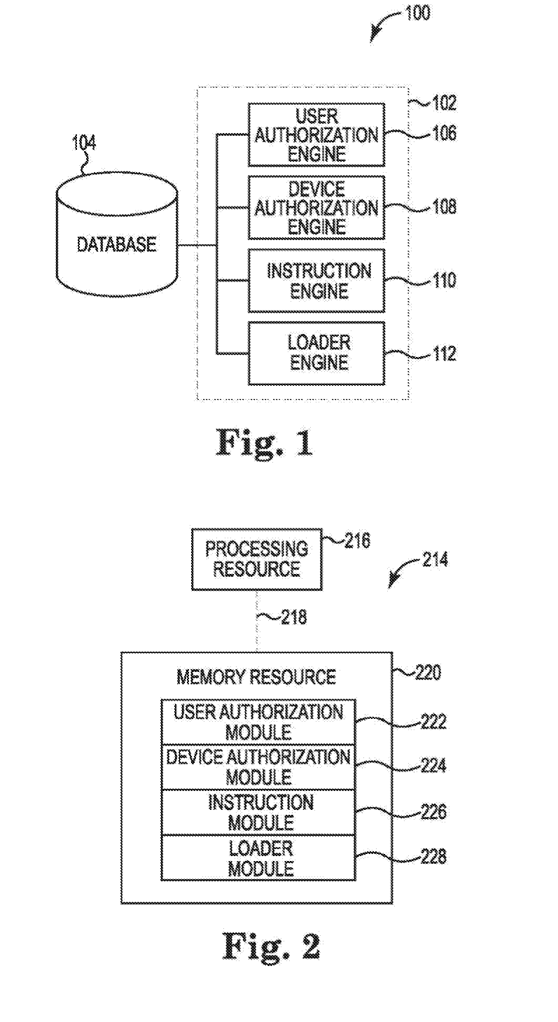

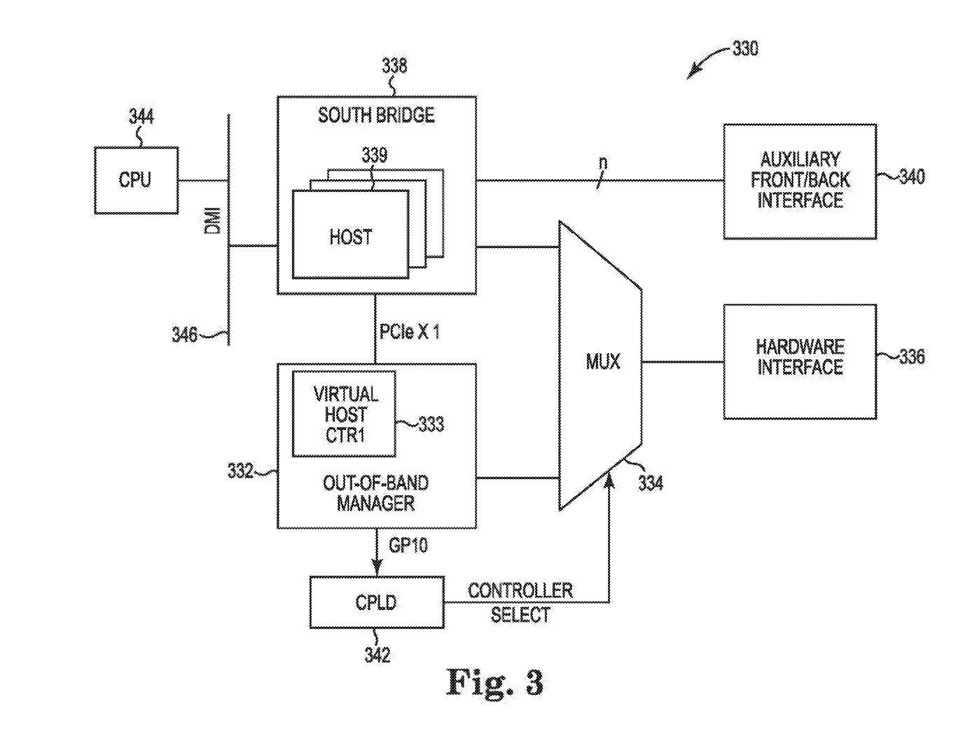

FIGS. 1 and 2 illustrate examples of system 100 and computing device 214 consistent with the present disclosure. FIG. 1 illustrates a diagram of an example of a system 100 for peripheral device security consistent with the present disclosure. The system 100 can include a database 104, a peripheral device security system 102, and/or a number of engines (e.g., user authorization engine 106, device authorization engine 108, instruction engine 110, loader engine 112). The peripheral device security system 102 can be in communication with the database 104 via a communication link, and can include the number of engines (e.g., user authorization engine 106, device authorization engine 108, instruction engine 110, loader engine 112). The peripheral device security system 102 can include additional or fewer engines that are illustrated to perform the various functions as will be described in further detail in connection with FIGS. 3-5.

The number of engines (e.g., user authorization engine 106, device authorization engine 108, instruction engine 110, loader engine 112) can include a combination of hardware and programming, but at least hardware, that is configured to perform functions described herein (e.g., authorize credentials of a user and authorize a physical location of the user, determine a device type of a peripheral device coupled to a hardware interface of the system and to determine if the user is authorized to utilize the device type, determine a number of authorized instructions for the peripheral device based on the device type, load authorized instructions from the peripheral device to a host interface of the system and exclude unauthorized instructions from the peripheral device, determine a quantity of time between authorizing the user with the user authorization engine and authorizing the dive with the device authorization engine, wherein authorization of the user and the device fails when the quantity of time is greater than a threshold quantity of time, etc.). The programming can include program instructions (e.g., software, firmware, etc.) stored in a memory resource (e.g., computer readable medium, machine readable medium, etc.) as well as hard-wired program (e.g., logic).

The user authorization engine 106 can include hardware and/or a combination of hardware and programming, but at least hardware, to authorize credentials of a user and authorize a physical location of the user. Authorizing credentials of the user can include authorizing a user name and password combination corresponding to the user. Authorizing credentials of the user can include verifying an identity of the user. Verifying the identity of the user can be utilized to determine what functions the user is authorized to perform on the computing system. For example, the identity of the user can identify a number of peripheral devices that a user can utilize with the computing system.

The device authorization engine 108 can include hardware and/or a combination of hardware and programming, but at least hardware, to determine a device type of a peripheral device coupled to a hardware interface of the system and to determine if the user is authorized to utilize the device type. The device authorization engine 108 can determine the device type by determining features of the device such as: a Class, SubClass and/or Protocol of the device. As described herein, the device type can be utilized to determine if the user is authorized to utilize the device. In some examples, the determined device type can be utilized to determine a number of authorized instructions for the device.

The instruction engine 110 can include hardware and/or a combination of hardware and programming, but at least hardware, to determine a number of authorized instructions for the peripheral device based on the device type. The number of authorized instructions for the peripheral device can correspond to a functionality of the determined device type. For example, the determined device type can be a computing mouse. In this example, the authorized instructions can include instructions that normally would be executed by a computing mouse (e.g., directing motion of a pointer on a display based on two-dimensional motion of the computing mouse, selections, options, etc.).

In some examples, the authorized instructions can include a portion of the instructions that would normally be executed by the peripheral device. For example, the number of authorized instructions can also be based on the authorized user. In this example, the user may only be able to utilize the peripheral device for navigation and not be able to utilize the peripheral device for other functions that the peripheral device would normally be able to perform (e.g., selecting, inserting text, deselecting, etc.).

The loader engine 112 can include hardware and/or a combination of hardware and programming, but at least hardware, to load authorized instructions from the peripheral device to a host interface of the system and exclude unauthorized instructions from the peripheral device. The loader engine 112 can be utilized to receive instructions from the peripheral device and load authorized instructions to the host interface of the system. Thus, the user can utilize the peripheral device to interact with the host interface via the loader engine 112 while being limited to functions that are authorized for the device type and for the particular user. Limiting the instructions to only authorized instructions can ensure that the device type was determined correctly and that only instructions that are authorized for the device and user are loaded to the host interface.

FIG. 2 illustrates a diagram of an example computing device 214 consistent with the present disclosure. The computing device 214 can utilize software, hardware, firmware, and/or logic to perform functions described herein.

The computing device 214 can be any combination of hardware and program instructions configured to share information. The hardware, for example, can include a processing resource 216 and/or a memory resource 220 (e.g., computer-readable medium (CRM), machine readable medium (MRM), database, etc.). A processing resource 216, as used herein, can include any number of processors capable of executing instructions stored by a memory resource 220. Processing resource 216 may be implemented in a single device or distributed across multiple devices. The program instructions (e.g., computer readable instructions (CRI)) can include instructions stored on the memory resource 220 and executable by the processing resource 216 to implement a desired function (e.g., authorize a user and a corresponding peripheral device coupled to a hardware interface, receive a number of instructions from the peripheral device via the hardware interface, determine authorized instructions for the peripheral device based on an identity of the authorized user and a determined device type of the peripheral device, load authorized instructions from the number of instructions to a host interface via a virtual host controller and exclude unauthorized instructions from the peripheral device, etc.).

The memory resource 220 can be in communication with a processing resource 216. A memory resource 220, as used herein, can include any number of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, and/or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a local communication link 218 can include an electronic bus internal to a machine (e.g., a computing device) where the memory resource 220 is one of volatile, non-volatile, fixed, and/or removable storage medium in communication with the processing resource 216 via the electronic bus.

A number of modules (e.g., user authorization module 222, device authorization module 224, instruction module 226, loader module 228) can include CRI that when executed by the processing resource 216 can perform functions. The number of modules (e.g., user authorization module 222, device authorization module 224, instruction module 226, loader module 228) can be sub-modules of other modules. For example, the device authorization module 224 and the instruction module 226 can be sub-modules and/or contained within the same computing device. In another example, the number of modules (e.g., user authorization module 222, device authorization module 224, instruction module 226, loader module 228) can comprise individual modules at separate and distinct locations (e.g., CRM, etc.).

Each of the number of modules (e.g., user authorization module 222, device authorization module 224, instruction module 226, loader module 228) can include instructions that when executed by the processing resource 216 can function as a corresponding engine as described herein. For example, the user authorization module 222 can include instructions that when executed by the processing resource 216 can function as the user authorization engine 106. In another example, the device authorization module 224 can include instructions that when executed by the processing resource 216 can function as the device authorization engine 108. In another example, the instruction module 226 can include instructions that when executed by the processing resource 216 can function as the instruction engine 110. Furthermore, the loader module 228 can include instructions that when executed by the processing resource 216 can function as the loader engine 112.

FIG. 3 illustrates a diagram of an example of a peripheral device security system 330 consistent with the present disclosure. The peripheral device security system 330 can be utilized to prevent unwanted access to a computing system via a hardware interface 336. The hardware interface 336 can include, but is not limited to a USB front interface, an NFC interface, among other interfaces that can communicatively couple a peripheral device to a host interface of the computing system.

The peripheral device security system 330 can include a hardware interface 336 (e.g., primary front interface, primary front USB, etc.). The hardware interface 336 can be a physical connection or wireless connection that can communicatively couple (e.g., connect via a communication session, etc.) a peripheral device to the computing device. The hardware interface 336 can be coupled to a multiplexor (mux) 334. The multiplexor 334 can be a device that can receive signals from a peripheral device coupled to the hardware interface 336. In some examples, the multiplexor 334 can receive signals from a plurality of hardware interfaces 336.

The multiplexor 334 can receive the signals from the hardware interface 336 and transfer the signals to an out-of-band manager 332 (e.g., integrated lights out (iLo), etc.). The out-of-band manager 332 can act as a gatekeeper between the hardware interface 336 and a bridge 338 to the host interface 339. In some examples, the multiplexor 334 can send all signals from the hardware interface 336 to the out-of-band manager 332.

In some examples, the out-of-band manager 332 can authorize a user's credentials and/or authorize a user's physical location. In some examples, the user can be authorized by a number of credentials of the user. As described herein, authorizing a user's credentials can include requesting a user's user name and password combination. The user name and password combination can correspond to a user's account information.

The user's account information can include security information that can be utilized to determine a number of device types that a user is authorized to utilize with the computing system. For example, the security information can be utilized to determine that a particular user can utilize navigational peripheral devices such as a computing mouse. The security information can also be utilized to determine a number device types that the particular user may not utilize with the computing system. For example, the security information can be utilized to determine that a particular user may not utilize peripheral devices capable of inserting instructions and/or making changes to the host interface of the computing system.

The out-of-band manager 332 can also authorize the user's physical location to confirm that the determined account information corresponding to the user name and password correctly corresponds to a user physically present at the hardware interface 336. Confirming that the determined account information corresponds to the user name and password can add additional security and assurance that the user of the device is correctly determined. In addition, authorizing the user's physical location can prevent unauthorized access to the host interface 339 via the hardware interface 336.

The out-of-band manager 332 can authorize the user's physical location by a number of different authorization techniques. In some examples, the authorization techniques can include a biometric test to confirm that the user at the physical location is the same user that corresponds to the authorized user credentials. For example, the out-of-band manager 332 can be coupled to a biometric authorization device (e.g., fingerprint scanner, retinal scanner, etc.) that is coupled to the computing device. In some examples, the out-of-band manager 332 can be coupled to an authorization device that is physically located near the hardware interface 336.

In some examples, the user can be prompted to provide physical location authorization when a peripheral device is coupled to the hardware interface 336. For example, a user can couple a peripheral device to the hardware interface 336 and a timer can begin (e.g., counting down a particular quantity of time, etc.) for authorizing that the user is physically located at or near the hardware interface 336. In this example, the user must authorize that they are physically located near the hardware interface 336 within the time allowed by the timer.

In some examples, the out-of-band manager 332 can authorize a peripheral device coupled to the hardware interface 336. As described herein, authorizing the peripheral device can include determining a device type of the peripheral device. Determining the device type can include determining the functionality of the peripheral device. The functionality of the peripheral device can be utilized to determine a number of authorized instructions based on the determined device type. For example, the out-of-band manager 332 can determine the device type based on a class, subclass, and/or protocol of the peripheral device.

In some examples, the out-of-band manager 332 can determine a number of authorized instructions from the instructions of the determined device type based the determined security information of the authorized user. For example, the determined device type can be a keyboard. In this example, the authorized instructions of the keyboard can include, but are not limited to: text insertion or deletion, number insertion or deletion, navigation, among other functions of a keyboard. In this example, the out-of-band manager 332 can determine that only a portion of the number of authorized instructions for the peripheral device are authorized for a particular user.

In some examples, the out-of-band manager 332 can be utilized to couple the peripheral device to the bridge 338 and the host 339 via the hardware interface 336 and the multiplexor 334. For example, the out-of-band manager 332 can receive instructions from the peripheral device via the hardware interface 336 and load instructions to the host 339. In some examples, the out-of-band manager 332 can load only instructions that are authorized based on the device type and/or based on the authorized user of the peripheral device.

In some examples, the out-of-band manager 332 can load instructions from the peripheral device coupled to the hardware interface 336 via a virtual host controller 333. The out-of-band manager 332 can also utilize a complex programmable logic device (CPLD) 342 to control a functionality of the multiplexor 334. For example, the out-of-band manager 332 can switch the multiplexor 334 from sending instructions to the out-of-band manager 332 to sending instructions to the host 339. That is, in some embodiments, the out-of-band manager 332 can couple the hardware interface 336 to the host 339 when the user has been authorized and the peripheral device coupled to the hardware interface 336 has been authorized.

In some examples, the system 330 can include a number of auxiliary interfaces 340 that are coupled to the host 339 via a bridge 338. In addition, the system 330 can include a central processing unit 344 that is coupled to the bridge 338 via a direct media interface 346. The system 330 can also include a number of other devices comprising software and/or hardware to perform a number of functions. In some examples, the number of functions can include functions provided by a server.

The system 330 can provide additional security for peripheral devices that can be coupled to a hardware interface 336. As described herein, the hardware interface 336 can be a universal serial bus (USB) that can be physically coupled to a number of peripheral devices. The system 330 can provide additional security by coupling a peripheral device to the out-of-band manager 332. The out-of-band manager 332 can authorize the peripheral device and authorize a user attempting to utilize the peripheral device. Authorizing the peripheral device and the user attempting to utilize the peripheral device can make the out-of-band manager 332 a gatekeeper between a peripheral device and a host 339. Thus, as described herein, the system 330 can allow secure utilization of the hardware interface 336 by preventing unauthorized instructions from a peripheral device from being loaded to the host 339.

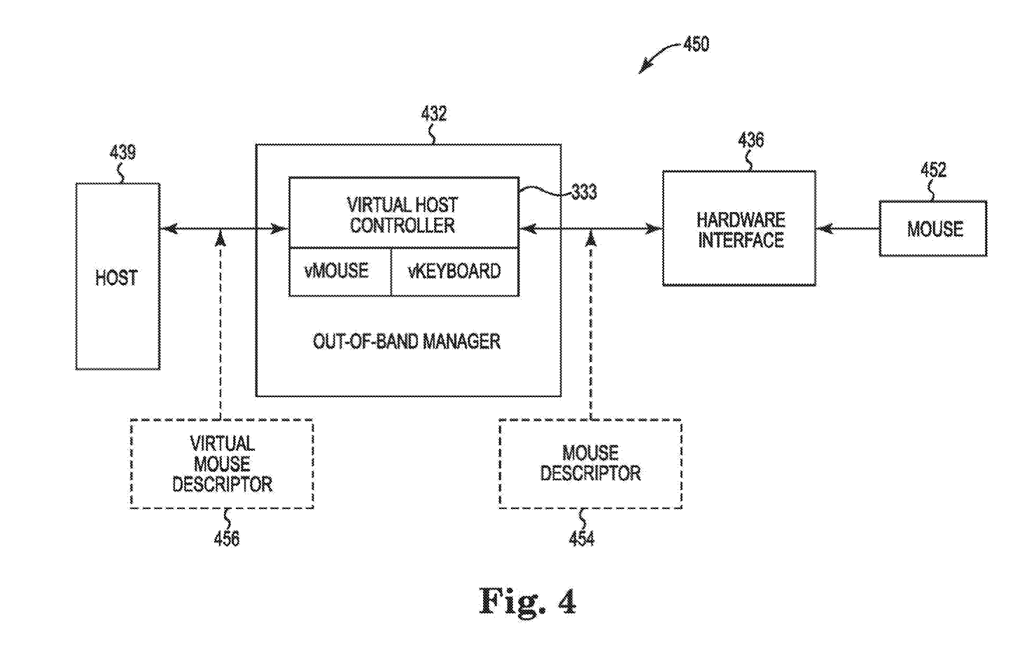

FIG. 4 illustrates a diagram of an example of a peripheral device security system 450 consistent with the present disclosure. The peripheral device security system 450 can provide additional security for peripheral devices that are coupled to a hardware interface 436. The peripheral device security system 450 illustrates the peripheral device as a computing mouse 452. However, a number of different peripheral devices can also be utilized in place of the computing mouse 452.

In some examples, the computing mouse 452 can be coupled to the hardware interface 436. For example, the computing mouse 452 can be physically coupled to the hardware interface 436 via a USB port. When the computing mouse 452 is coupled to the hardware interface 436 a mouse descriptor 454 can be sent from the mouse 452 to the out-of-band manager 432 via the hardware interface 436. As described herein, the mouse descriptor information 454 can include, but is not limited to a class, subclass and/or protocol corresponding to the computing mouse 452.

In some examples, the computing mouse 452 can be authorized by the out-of-band manager 432 with a physical authentication process and a device type authentication process, as described herein. For example, the mouse descriptor information 454 can be utilized by the out-of-band manager 432 to authorize the computing mouse 452. That is, the out-of-band manager 432 can authorize a number of instructions for the computing mouse 452 via the mouse descriptor information 454. As described herein, the authorized number of instructions can be based on a determined device type and/or based on an authorized user of the computing mouse 452. For example, the out-of-band manager 432 can determine a number of instructions that are authorized for the computing mouse 452.

In some examples, the device type authentication process can include determining a device type of the peripheral device, determining if an identified user is allowed to utilize the determined device type, and/or determining a number of instructions operable by the determined device type. That is, the device type authentication process can include determining that the device is a computing mouse 452, determining if an authorized user is authorized to utilize the computing mouse 452, and/or determining a number of instructions that are operable (e.g., authorized instructions, instructions to be loaded by the out-of-band manager 432, etc.) for the computing mouse 452.

The number of authorized instructions can include navigational instructions and selection instructions that are specific to the computing mouse 452. In some examples, the number of authorized instructions can also be based on an authorized user. For example, the number of authorized instructions for a user can include a portion of the authorized instructions that are specific to the computing mouse 452. In this example, the portion of the authorized instructions can include the navigational instructions but not include the selection instructions when the user is not authorized to utilize the selection instructions.

The out-of-band manager 432 can include a virtual host controller 433. The virtual host controller 433 can provide a virtual connection between the computing mouse 452 and a host 439 via a virtual mouse descriptor 456. The out-of-band manager 432 can send the virtual mouse descriptor 456 as instructions to the host 439. In some examples, only authorized instructions from the computing mouse 452 are loaded to the host 439 via the virtual host controller 433. For example, the out-of-band manager 432 may only load instructions that are authorized for the device type of the computing mouse 452 and/or instructions that are authorized for a user utilizing the computing mouse 452. In this example, the out-of-band manager 432 can receive unauthorized instructions from the computing mouse 452 and not load the instructions to the host 439 via the virtual host controller 433.

The system 450 can provide additional security for peripheral devices such as a computing mouse 452. The system 450 can utilize an out-of-band manager 432 such as an integrated lights out (iLo) to act as a gatekeeper between peripheral devices and a host 439. The system 450 can protect the host 439 from security threats that utilize a hardware interface 436 such as a USB port. The out-of-band manager 432 can protect the host 439 by authorizing the peripheral device and/or authorizing the physical location of a user of the peripheral device as described herein. In addition, the out-of-band manager 432 can protect the host 439 by loading only authorized instructions from the peripheral device to the host 439.

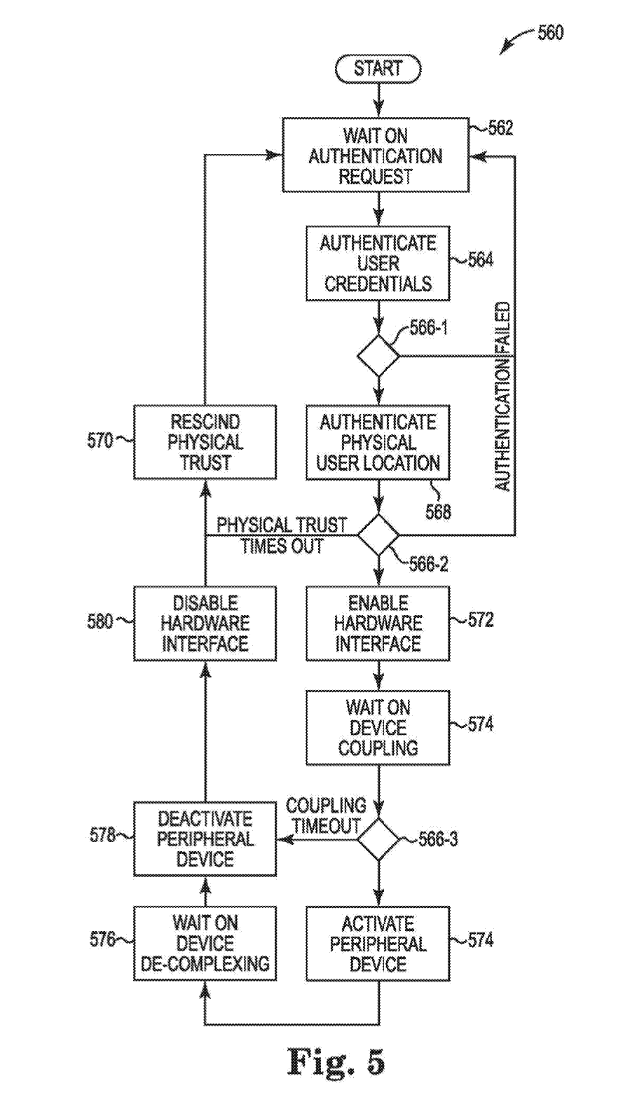

FIG. 5 is a flow chart of an example of a method 560 for peripheral device security consistent with the present disclosure. As described herein, the method 560 for peripheral device security can provide additional security for peripheral devices that utilize a hardware interface of a computing device. The method 560 can ensure that instructions loaded to a host interface of the computing device are not malicious instructions from an unauthorized peripheral device or unauthorized user. The method 560 can be executed by a system 330 as referenced in FIG. 3, a system 450 as referenced in FIG. 4, and/or other computing system such as a computing server.

The method 560 can begin by waiting on an authentication request at 562. Waiting on the authentication request can include waiting for a peripheral device to be coupled to a hardware interface. Upon connection of the peripheral device, the method can receive an authentication request. In some examples, the authentication request can include a request by a user to be authenticated for utilizing a particular peripheral device and/or a particular hardware interface. In some examples, the method 560 can include authenticating and/or authorizing a number of user credentials at 564. The number of user credentials can include, but are not limited to a user name and password combination specific to the user, among other forms of user credentials (e.g., identification number, social security number, etc.) that can identify a user.

At 566-1 the method 560 can determine if the user credentials from a user are authenticated or denied. If the user credentials are denied, the method 560 can then wait again for an authentication request at 562. When the user credentials are authenticated, the method 560 can include authenticating the physical location of the user. As described herein, authenticating the physical location can include determining whether the user is at a physical location of a hardware interface. In some examples, authenticating the physical location of the user can include utilizing a biometric test (e.g., fingerprint scan, retinal scan, etc.) of the user to confirm that the user is physically located at the hardware interface.

In some examples, authenticating the physical location of the user at 568 can include initiating a timer (e.g., a quantity of time) for receiving the authentication of the physical location of the user. For example, there can be an allotted quantity of time for authenticating the user's physical location after receiving the user's credentials. At 566-2, the method 560 can include determining whether the authenticated user credentials correspond to the authenticated physical location of the user. That is, at 566-2, the method 560 can include determining whether the user credentials received and authenticated at 564 correspond to the determined physical location of the same user.

When the user credentials and physical location of the user are not authenticated, the physical trust of the user can be rescinded at 570. In some examples, the method 560 can start over by waiting for an authentication request at 562. When the user credentials and physical location of the user are authenticated, the hardware interface can be enabled at 572. In some examples, the hardware interfaces for a computing system can be disabled without user credential authentication and/or physical location of the user authentication. That is, a direct connection between the hardware interface and the host interface can be disabled. In some examples, a multiplexor can be utilized to disable physical connections between the hardware interface and the host interface. By disabling the hardware interface prior to authentication of a user's credentials and physical location of the user, unauthorized users are not able to utilize a peripheral device via the hardware interface.

Enabling the hardware interface can include supplying power and communication to the hardware interface so that a peripheral device can be utilized via the hardware interface. At 574, the method 560 can include waiting for the peripheral device to be coupled to the hardware interface. In some examples, coupling the peripheral device to the hardware interface can include inserting a USB peripheral device to a USB port of the computing device. In some examples, a timer can be used to limit a quantity of time for coupling the peripheral device to the hardware interface. The timer can be initiated when the hardware interface is enabled at 572. Thus, the timer can limit the amount of time that a user can couple the peripheral device to the hardware interface. The timer can prevent a first user from enabling the hardware interface and at a later time a second user being able to utilize the hardware interface.

At 566-3, the method 560 can include determining when the quantity of time for the timer is over. When the timer has stopped and/or when the quantity of time is over, the peripheral device can be deactivated at 578. When the peripheral device is coupled to the hardware interface prior to the timer expiring, the peripheral device can be activated at 574. As described herein, activating the peripheral device can include utilizing an out-of-band manager (e.g., iLo, etc.) to load instructions from the peripheral device to a host interface of the computing device (e.g., server).

As described herein, activating the peripheral device can include loading only instructions that are authorized instructions for the peripheral device type and/or for the authorized user. The authorized instructions can be determined by the out-of-band manager as described herein. The peripheral device can be activated until it is determined that the peripheral device is de-coupled from the hardware interface at 576. When the peripheral device is de-coupled from the hardware interface, the method 560 can return to 562 and wait for an authentication request. In addition, the hardware interface can be deactivated when the peripheral device is de-coupled from the hardware interface.

The method 560 can be utilized to provide a secure hardware interface connection that can be utilized to authorize a peripheral device for a particular user. The method 560 can provide a security process for authenticating the user based on user credentials, authenticating the physical location of the user, and/or authenticating the device type so that only authorized instructions are loaded to the host interface of the computing device.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed is:

1. A system for peripheral device security, comprising:
a hardware interface coupled to an out-of-band manager; and
the out-of-band manager to:
authorize a peripheral device via the hardware interface; and
load instructions from the peripheral device to a host interface.

2. The system of claim 1, wherein the peripheral device is authorized by the out-of-band manager with a physical authentication process and a device type authentication process.

3. The system of claim 2, wherein the physical authentication process includes:
determining an identity of a user of the peripheral device via user credentials; and
authorizing that the user is physically present with the hardware interface via a biometric test that is compared to the user credentials.

4. The system of claim 2, wherein the device type authentication process is to:
determine a device type of the peripheral device;
determine if an identified user is allowed to utilize the determined device type; and
determine a number of instructions operable by the determined device type.

5. The system of claim 1, wherein the loaded instructions from the peripheral device to the host interface are limited to a determined number of instructions that are operable by the authorized peripheral device.

6. The system of claim 1, wherein the hardware interface is coupled to the out-of-band manager via a multiplexor.

7. The system of claim 1, wherein the out-of-band manager loads instructions from the peripheral device to the host interface via a virtual device descriptor.

8. A system for peripheral device security, comprising:
an user authorization engine to authorize credentials of a user and authorize a physical location of the user;
a device authorization engine to determine a device type of a peripheral device coupled to a hardware interface of the system and to determine if the user is authorized to utilize the device type;
an instruction engine to determine a number of authorized instructions for the peripheral device based on the device type; and
a loader engine to load authorized instructions from the peripheral device to a host interface of the system and exclude unauthorized instructions from the peripheral device.

9. The system of claim 8, wherein a direct connection between the hardware interface and the host interface is disabled.

10. The system of claim 8, wherein the loader engine utilizes a virtual host controller to load the authorized instructions from the peripheral device to the host interface of the system.

11. The system of claim 8, comprising a timer engine to determine an amount of time between authorizing the user with the user authorization engine and authorizing the device with the device authorization engine, wherein authorization of the user and the device fails when the amount of time is greater than a threshold amount of time.

12. A non-transitory computer readable medium storing instructions executable by a processor for peripheral device security, wherein the instructions are executable to:
authorize a user and a corresponding peripheral device coupled to a hardware interface;
receive a number of instructions from the peripheral device via the hardware interface;
determine authorized instructions for the peripheral device based on an identity of the authorized user and a determined device type of the peripheral device;
load authorized instructions from the number of instructions to a host interface via a virtual host controller and exclude unauthorized instructions from the peripheral device.

13. The medium of claim 12, wherein instructions from the hardware interface are loaded to the host interface via the virtual host controller.

14. The medium of claim 12, wherein the number of instructions from the peripheral device are received through a multiplexor coupled to the hardware interface.

15. The medium of claim 14, wherein the multiplexor disables physical connections between the hardware interface and the host interface.
